(19) United States
(12) Patent Application Publication
(10) Pub. No.: US 2001/0047959 A1
(43) Pub. Date: Dec. 6, 2001

(54) Polyacrylonitrile-based filtration membrane in a hollow fiber state

(75) Inventors: Teruhiko Oishi, Fuji-Shi (JP); Noboru Kubota, Fuji-Shi (JP)

Correspondence Address: BIRCH STEWART KOLASCH & BIRCH, PO BOX 747, FALLS CHURCH, VA, 22040-0747, US

(73) Assignee: Asahi Kasei Kabushiki Kaisha

(21) Appl. No.: 09/887,338

(22) Filed: Jun. 25, 2001

Related U.S. Application Data
(63) Continuation of application No. 09/242,567, filed on Feb. 19, 1999.
Application No. 09/242,567 is a 371 of international application No. PCT/JP98/02736, filed on Jun. 19, 1998.

(30) Foreign Application Priority Data
Jun. 20, 1997 (JP) 09-164653
Oct. 28, 1997 (JP) 09-295093

(51) Int. Cl. B01D 63/02

(52) U.S. Cl. 210/500.23; 210/500.43; 264/41

(57) ABSTRACT

A polyacrylonitrile-based hollow fiber filtration membrane, wherein said membrane comprises a sponge structure free from polymer defect sites of sizes larger than 10 μm inside the membrane, pore sizes of the membrane continuously decrease towards both surfaces of the membrane, and the pore size on the outer surface of the membrane is differentiated from that on the inner surface.

### TECHNICAL FIELD

The present invention relates to a high performance polyacrylonitrile-based hollow fiber filtration membrane having high strength, elongation, and water permeability as well as distinguished chemical resistance and filtration reliability.

### BACKGROUND ART

Recent progress of technology has been made using membranes having permselectivity in separation operations and this technology is now practically utilized in the fields of the food industry, pharmaceutical industry, electronic industry, medical treatment, treatment of drinking water and condensation treatment of the nuclear power plants, cooling water, etc. For membrane materials, cellulose-based resin, polyamide-based resin, polyacrylonitrile-based resin, polycarbonate-based resin, polysulfone-based resin, etc. are now available, and above all the polyacrylonitrile-based resin has good mechanical characteristics as well as distinguished membrane hydrophilicity and water permeability. Thus, the polyacrylonitrile-based membrane has been developed with emphasis on separability properties, water permeability or mechanical strength, and various membrane structures and chemical compositions have been proposed according to the desired purposes.

For example, JP-B-60-39404 discloses a membrane structure comprising a dense layer only on the outer surface of the membrane, a layer of net structure on the inner side of the dense layer and a layer having macrovoids open to the inner surface on the inner side of the layer of net structure. The membrane of such a structure has distinguished selectivity, but owing to its low water permeability much more membrane modules are required for applications relating to purification of a large amount of water such as water supply, etc., resulting in use of apparatuses of larger size and increases in the treatment cost.

On the other hand, JP-A-63-190012 discloses a membrane of polyacrylonitrile with an ultra-high degree of polymerization in a macrovoid-free structure comprising a dense layer only on the outer surface of the membrane. The membrane has a distinguished mechanical strength, but its water permeability is not satisfactory.

JP-A-6-65809 likewise discloses a membrane of polyacrylonitrile with an ultra-high degree of polymerization in a structure comprising a dense layer only on the outer surface and a layer having macrovoids on the dense layer. The dense layer of the membrane has a larger pore size and the membrane has a poor balance between water permeability and the selectivity.

The membrane comprising a dense layer only on the outer surface may suffer from permeation of matter properly blocked by the membrane when the dense layer on the outer surface is damaged for any reason. Such a membrane lacks filtration reliability.

The conventional polyacrylonitrile-based filtration membrane has a poor chemical resistance, as compared with, for example, a polysulfone-based filtration membrane, etc. and thus is not applicable to the field requiring cleaning with a highly concentrated chemical. That is, its use is limited.

Changes in the physical properties of polyacrylonitrile-based filtration membrane in a chemical solution have been so far caught as an inevitable phenomenon due to the material characteristics proper to polyacrylonitrile-based polymers, and thus it has been so far regarded as impossible by nature to improve the chemical resistance of polyacrylonitrile-based filtration membrane.

### DISCLOSURE OF THE INVENTION

The present inventors have invented a polyacrylonitrile-based membrane having high water permeability, strength and elongation by providing an acrylonitrile-based polymer membrane having a membrane structure as not disclosed in the prior art, e.g. by making the structure free from internal macropores, and providing a compact layer on both surfaces of the membrane, while differentiating the pore size on one surface from another.

An object of the present invention is to provide a high performance polyacrylonitrile-based hollow fiber filtration membrane having high strength, elongation and water permeability as well as distinguished chemical resistance and filtration reliability.

Another object of the present invention is to provide a process for producing the high performance polyacrylonitrile-based hollow fiber filtration membrane.

The present polyacrylonitrile-based hollow fiber filtration membrane is characterized by a sponge structure free from polymer defect sites (macropores or voids) of sizes larger than 10 μm inside the membrane, the pore sizes continuously decreasing in a direction towards both surfaces of the membrane and the pore size on the outer surface of the membrane being differentiated from that on the inner surface. The present process for producing the polyacrylonitrile-based hollow fiber filtration membrane comprises discharging a membrane-forming solution comprising an acrylonitrile-based polymer, a solvent mixture of propylene carbonate and dimethylsulfoxide and an additive through a coaxial tube spinneret together with an bore solution capable of inducing phase separation of the membrane-forming solution and having a viscosity of 25 cp (centipoises) at 20° C., followed by passing this solution through an air gap and coagulation of the membrane in a coagulation bath.

### BRIEF DESCRIPTION OF THE DRAWINGS

FIG. 1 is an electron micrograph (magnification: ×400) showing the vertical cross-section (partial) of one embodiment of the present hollow fiber filtration membrane.

FIG. 2 is another electron micrograph (magnification: ×3,000) of a cross-section near the outer surface of the hollow fiber filtration membrane, as shown in FIG. 1.

FIG. 3 is other electron micrograph (magnification: ×3,000) of a cross-section near the inner surface of the hollow fiber filtration membrane, as shown in FIG. 1.

FIG. 4 is a further electron micrograph (magnification: ×10,000) of the inner surface of the hollow fiber filtration membrane, as shown in FIG. 1.

FIG. 5 is a still further electron micrograph (magnification: ×10,000) of the outer surface of the hollow fiber filtration membrane, as shown in FIG. 1.

FIG. 6 is a cross-section of a hollow fiber membrane, positioned in a vessel for measuring a fluid linear velocity.

### BEST MODE FOR CARRYING OUT THE INVENTION

The structure of the present hollow fiber filtration membrane (which will be hereinafter also referred to merely a “membrane”) will be described below:

The present polyacrylonitrile-based membrane is in an integrally continuous structure extending from one surface of the membrane to another, e.g. from the inner surface to the outer surface. The zone between one surface of the membrane and another surface, i.e. the membrane interior, is a net structure having mesh sizes (pore sizes) of not more than 10 μm and being free from defect sites (macropores or voids) of larger sizes than 10 μm. This structure will be referred to as a “sponge structure” in the present invention.

Pores in the net structure in the membrane interior have an inclined structure in the vertical cross-section in the longitudinal direction of the membrane, where the pore sizes are continuously decreased towards both surfaces of the membrane. This is similar to several cylindrical faces each having a concentric center axis extending in the longitudinal direction of the hollow fiber filtration membrane. Average pore sizes of pores on the respective faces are continuously decreased towards the surfaces throughout the membrane interior. Furthermore, the pore sizes on the outer surface of the present membrane are differentiated from those on the inner surface thereof.

A typical example of the present membrane will be described in detail below, referring to the drawings.

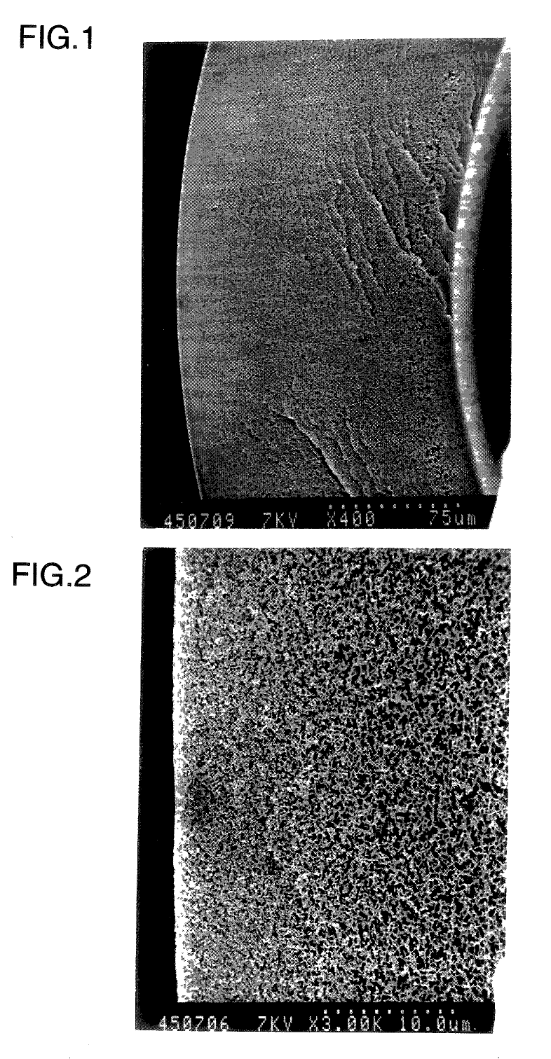

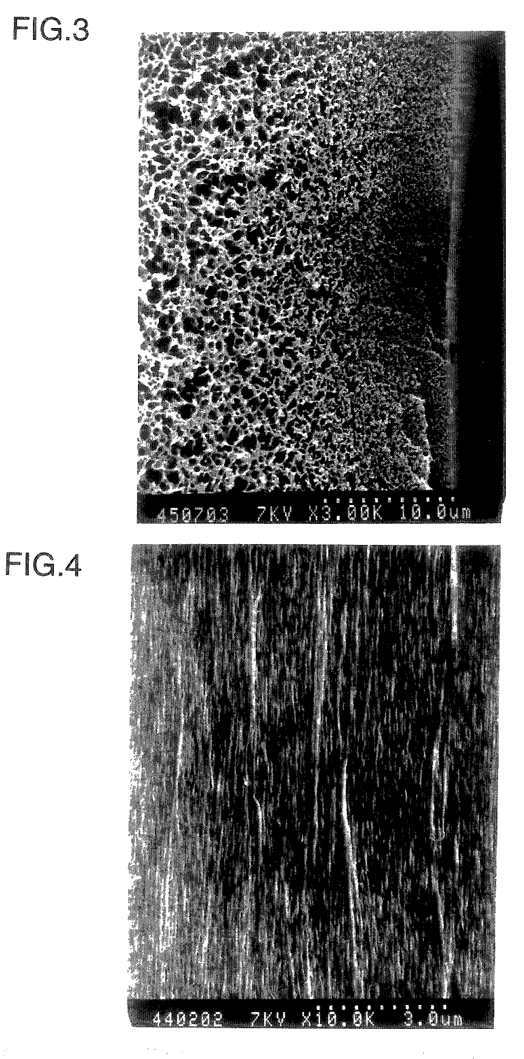

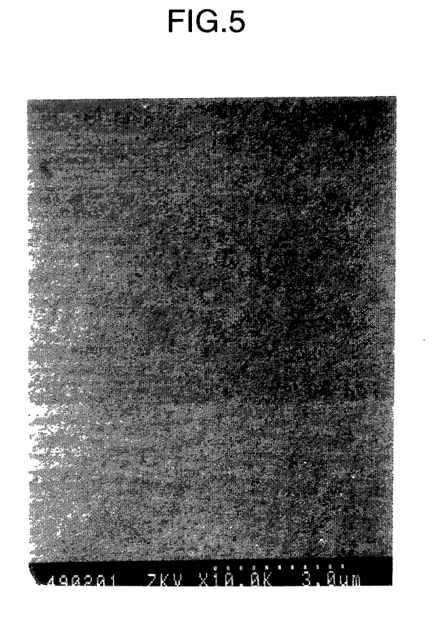

FIG. 1 is an electron micrograph of the vertical cross-section (partial) to the longitudinal direction of a hollow fiber filtration membrane, FIG. 2 is an enlarged micrograph of the cross-section near the outer surface of the hollow fiber filtration membrane of FIG. 1, and FIG. 3 is an enlarged micrograph of the cross-section near the inner surface of the hollow fiber filtration membrane of FIG. 1. Furthermore, FIG. 4 is an electron micrograph showing the state on the inner surface of the membrane and FIG. 5 is another electron micrograph showing the state on the outer surface of the membrane.

As shown in FIGS. 1 to 3, the membrane has an inclined structure where the average pore size is gradually and continuously decreased from the center of the membrane thickness towards the outer surface or the inner surface of the membrane, i.e. has a net structure having an anisotropy with respect to the pore sizes. The membrane surfaces are in a dense structure, but the present membrane appears not to have such a distinct skin layer as known so far. FIG. 5 shows the state of dense outer surface, whereas a pattern of numerous slit-shaped stripes or slit-shaped pores are observed in the longitudinal direction of the membrane on the inner surface, as evident from FIG. 4.

Pores open to the surfaces of the membrane are preferably in a circular, ellipsoidal, net or slit-like shape, and pores open to the outer surface is more preferably in a circular, ellipsoidal or net shape. Pores open to the surfaces of the membrane have an average pore size of not more than 1 μm, preferably 0.01 μm to 0.5 μm, more preferably 0.01 μm to 0.3 μm. Pores larger than 1 μm have a lower effect on removal of fine particles as a tendency. To obtain a high water permeability, it is preferable that the average pore size on at least one surface of the membrane is not less than 0.01 μm. Shapes and sizes of pores open to the surfaces of the membrane can be observed and determined by electron microscope.

Average pore size \overline{D} of pores open to the inner and outer surfaces is a value shown by the following equation:

$$\overline{D} = \sqrt{\frac{{( {Di}^{2} )}^{2} + … + {( {Dn}^{2} )}^{2}}{{Di}^{2} + … + {Dn}^{2}}} \qquad ( 1 )$$

wherein

\overline{D}: average pore size

Di: measured pore size of ith pore

Dn: measured pore size of nth pore

Measured pore size Di and Dn show pore diameters, when the pores are approximate to circular shapes, or show diameters of circles having the same area as those of the pores, when the pores are not in a circular shape.

To improve the water permeability of the membrane, it is preferable that the pores are made open to both inner and outer surfaces of the membrane, where the sizes of pores to be made open can be selected by desired requirements (use), but the sizes of pores to be made open on at least one surface of the membrane (pore sizes) must be sizes for assuring the filtration reliability of the membrane, that is, smaller pore sizes than sizes of matters to be blocked by filtration. Furthermore, to improve the water permeability of the membrane, it is necessary that pore sizes on at least one surface of the membrane are larger than those on another surface. Membranes for water treatment have a larger average pore size on the inner surface than that on the outer surface, because raw water to be filtered is more often charged from the outer surface side.

The present membrane has a structure as mentioned above, and thus even if outer dense surface sites are damaged, matter to be removed can be blocked by other inner dense surface sites. That is, the present membrane has high filtration reliability and water permeability.

Furthermore, the present membrane has surprisingly a high chemical resistance equivalent to that of a polysulfone-based hollow fiber filtration membrane.

The present polyacrylonitrile-based hollow fiber filtration membrane has percent changes of less than 20% in breaking strength and breaking elongation of the hollow fiber membrane before and after dipping into an aqueous hypochlorite solution having an available chlorine concentration of 1,200 ppm and containing 0.1 N (normal) alkali at 25° C. for 120 hours.

In the present invention, percent changes in breaking strength and breaking elongation are values calculated by the following equations, respectively:

Percent change (%) in breaking strength=(Sb/Sa)/Sb×100

wherein

Sb: Breaking strength before dipping into the aqueous hypochlorite solution

Sa: Breaking strength after dipping into the aqueous hypochlorite solution.

Percent change (%) in braking elongation=(Eb−Ea)/Eb×100

wherein

Eb: Breaking elongation before dipping into the aqueous hypochlorite solution

Ea: Breaking elongation after dipping into the aqueous hypochlorite solution.

Breaking strength and breaking elongation of a membrane can be measured by testing a thoroughly water-impregnated hollow fiber membrane having a sample length of 50 mm at 25° C. and a tensile speed of 10 mm/min by means of a tensil tester.

Breaking strength can be represented by the load (kgf) at breaking per hollow fiber membrane and breaking elongation (stretching) can be represented by the ratio of the elongated length at breaking to the original length (%).

The aqueous hypochlorite solution referred to in the present invention includes aqueous solutions of hypochlorous acid, sodium hypochlorite, potassium hypochlorite, calcium hypochlorite, etc., which are cleaning solutions to be used for recovery of the membrane properties.

For cleaning attached organic substance, the aqueous hypochlorite solution is preferably applied to membranes of any material in general. To improve the cleaning effect on organic substance attached to the membrane, it is preferable to add an alkali to the aqueous hypochlorite solution. However, though the cleaning effect can be increased when changing from the aqueous hypochlorite solution to the aqueous alkali-added hypochlorite solution, degradation of membranes composed of organic materials will also be larger as a tendency. Concentration of the alkali in the aqueous hypochlorite solution, when used as a cleaning agent, is not more than 5 N (normal), preferably not more than 1 N (normal), more preferably 0.01 N (normal) to 0.1 N (normal). When the concentration of an alkali exceeds 5 N (normal), degradation of polyacrylonitrile-based membrane will be larger as a tendency.

Generally, resistance of polyacrylonitrile-based membrane to a hypochlorite is low. For example, in the case of dipping the membrane into an aqueous sodium hypochlorite solution having an available chlorine concentration of 200 ppm and containing 0.1 N (normal) sodium hydroxide at room temperature around 25° C. for 5 days, the percent change in breaking elongation is 70% or more, and the breaking elongation is sometimes largely lowered. Thus, in the case of cleaning the polyacrylonitrile-based membrane with an aqueous hypochlorite solution, it has been so far necessary to use the aqueous hypochlorite solution at an available chlorine concentration of less than 200 ppm to avoid the degradation of the membrane. In case of the present hollow fiber filtration membrane, on the other hand, percent changes in breaking strength and breaking elongation are less than 20%, mostly not more than 5%, even if the available chlorine concentration of an aqueous hypochlorite solution to be used is made as high as 1,200 ppm.

Other chemical solutions for use to recover the membrane performance include, for example, aqueous solutions of an acid such as hydrochloric acid, sulfuric acid, phosphoric acid, nitric acid, acetic acid, citric acid, etc., aqueous solutions of an alkali such as sodium hydroxide, potassium hydroxide, calcium hydroxide, lithium hydroxides, strontium hydroxide, etc., and an aqueous hydrogen peroxide solution, etc. Even with these chemical solutions, the present membrane has percent changes in breaking strength and breaking elongation of less than 20%, mostly not more than 5%, under such conditions as the concentration: 1,200 ppm, solution temperature: 25° C. and dipping time: 120 hours. The foregoing conditions and results are one example showing that the present membrane has a good chemical resistance, and in actual practice the dipping time in the chemical solution, concentration and temperature of the aqueous oxidant solution or bath ratio of the membrane to the aqueous oxidant solution are not limited thereto.

The present process for producing the polyacrylonitrile-based hollow fiber filtration membrane will be described below, referring to a typical example.

The present membrane can be produced by discharging a membrane-forming solution substantially comprising an acrylonitrile-based polymer, a solvent mixture of propylene carbonate and other organic solvent and a specific additive though a well known coaxial tube spinneret of a tube-in-orifice type together with an internal solution, followed by passing the solutions through an air gap and coagulation in a coagulation bath.

Membrane-forming solution can be prepared by placing the solvent mixture, the additive and the acrylonitrile-based polymer into a temperature-controllable vessel, followed by dissolution by a stirrer or a mixer such as Henschel mixer, etc.

Acrylonitrile-based polymer for use in the present invention is an acrylonitrile homopolymer or an acrylonitrile-based copolymer, which comprises at least 70% by weight, preferably 85 to 100% by weight, of acrylonitrile and not more than 30% by weight, preferably 0 to not more than 15% by weight, of at least one vinyl compound copolymerizable with the acrylonitrile (the homopolymer and the copolymer will be hereinafter referred to as “acrylonitrile-based polymer” together). The acrylonitrile-based polymer has an intrinsic viscosity of preferably not less than 0.4 to less than 2.0. At an intrinsic viscosity of less than 0.4, the membrane will have a lower strength, whereas at an intrinsic viscosity of not less than 2.0, the solubility will be poor.

The vinyl compounds are not particularly limited and, any well known compounds can be used so long as they are copolymerizable with acrylonitrile. Preferable comonomer components include, for example, acrylic acid, methyl acrylate, ethyl acrylate, methacrylic acid, methyl methacrylate, ethyl methacrylate, itaconic acid, vinyl acetate, sodium acrylsulfonate, sodium methallylsulfonate, sodium p(para)-styrene-sulfonate, hydroxyethyl methacrylate, ethyl methacrylate triethylammonium chloride, ethyl methacrylate trimethylammonium chloride, vinylpyrrolidone, etc.

The solvent mixture comprising propylene carbonate and another organic solvent, which is important for obtaining the present membrane, is a mixture of propylene carbonate and at least one of acrylonitrile-based polymer-dissolvable organic solvents other than propylene carbonate. Acrylonitrile-based polymer-dissolvable organic solvents include, for example, N,N-dimethylformamide, N,N-dimethylacetamide, dimethyl sulfoxide, γ-butyrolactone, ethylene carbonate, N-methyl-2-pyrrolidone, 2-pyrrolidone, hexamethylene phosphamide, etc. To give high mechanical strength and elongation to the membrane, it is preferable to use a mixture of propylene carbonate and dimethyl sulfoxide. Without propylene carbonate, the present membrane is difficult to obtain. Concentration of propylene carbonate in the solvent mixture is not less than 2% by weight to not more than 99.9% by weight, preferably not less than 5% by weight to not more than 90% by weight, more preferably not less than 5% by weight to not more than 70% by weight. In a concentration lower than 2% by weight or a higher concentration than 99.9% by weight, the membrane having high mechanical strength and elongation and a distinguished water permeability is difficult to obtain as a tendency.

Concentration of the acrylonitrile-based polymer in the membrane-formable solution is not particularly limited, so long as it is in such a range as to form a film having desired properties as a membrane, and is usually 5 to 35% by weight, preferably 10 to 30% by weight. To attain a high water permeability and a large fractionable molecular weight, a lower concentration of acrylonitrile-based polymer is better, and 10 to 25% by weight is preferable.

The additive is not particularly limited, so long as it is compatible with the solvent and incapable of dissolving the acrylonitrile-based polymer. The additive may be to control the solution viscosity and the solution state. Water; salts; alcohols such as isopropyl alcohol, methanol, ethanol, propanol, butanol, etc.; ketones such as acetone, methyl ethyl ketone, etc.; glycols such as diethylene glycol, triethylene glycol, tetraethylene glycol, polyethylene glycol (weight average molecular weight: 200 to 35,000), etc.; glycerine; and polyvinylpyrrolidone (weight average molecular weight: 1,000 to 2,800,000), etc; can be used as the additive. Two or more kinds of additives can be used, the kind and added amount of which can be properly chosen as needs arise. A preferable additive is polyethylene glycol, more preferably polyethylene glycol having a weight average molecular weight of not more than 1,000. By using polyethylene glycol having a weight average molecular weight of not more than 1,000, a membrane having a distinguished strength can be obtained.

Concentration of the additive in the solution is 1 to 40% by weight, preferably 1 to 30% by weight, though the optimum concentration depends upon kinds and molecular weight of additive to be used.

The membrane-forming solution is discharged through a coaxial tube spinneret together with a bore solution which is capable of inducing phase separation of the membrane-forming solution and has a viscosity of 15 cp (centipoises) or more at 20° C., followed by passing through an air gap and coagulation in a coagulation bath, thereby making a hollow fiber membrane. The process can produce a membrane having pores with distinguished water permeability and blockability.

The bore solution is to form the hollow region and the inner surface of the hollow fiber filtration membrane. In the present invention, a liquid capable of inducing phase separation of the membrane-forming solution and having a viscosity of 15 cp (centipoises) or more at 20° C. is used as a bore solution to make pores with a distinguished water permeability open to the inner surface. The liquid includes, for example, ethylene glycol, propylene glycol, trimethylene glycol, 1,2-butylene glycol, 1,3-butylene glycol, 2-butyne-1,4-diol, 2-methyl-2,4-pentanediol, 2-ethyl-1,3-hexanediol, glycerine, tetraethylene glycol, polyethylene glycol 200, polyethylene glycol 300, polyethylene glycol 400, etc. Glycols or glycerols having a molecular weight of not more than 1,000 are preferable for use. With a liquid having a viscosity of less than 15 cp (centipoises) at 20° C., the thickness of an internal surface sites-forming layer will be increased and the water permeability will be decreased as a tendency.

Furthermore, the glycol or glycerol-based compound can be used as a mixed solution with water, an alcohol or a good solvent for the acrylonitrile-based polymer or as a mixed solution with water and a good solvent for the acrylonitrile-based polymer, so far as it is capable of inducing the phase separation and has a viscosity of 15 cp (centipoises) or more at 20° C. Good solvents for the acrylonitrile-based polymer include, for example, N,N-dimethylacetamide, dimethyl sulfoxide, γ-butyrolactone, ethylene carbonate, propylene carbonate, 2-pyrrolidone, N-methyl-2-pyrrolidone, hexamethylene phosphoramide, etc.

To make circular, ellipsoidal or reticular pores open to the inner surface, it is preferable to use a liquid having a viscosity of 50 cp (centipoises) or more at 20° C.

Methods for making pores open to the outer surface of a membrane, on the other hand, include, for example, a method of enclosing the air gap with a cylinder, etc., thereby keeping the temperature and humidity constant. If required, vapors of non-solvent for the acrylonitrile-based polymer used can be passed through the cylinder in the air gap at a constant flow rate. The term “air gap” herein used means a gap between the spinneret and the coagulation bath. Pore sizes on the outer surface of a membrane can be adjusted by changing the temperature and humidity in the air gap. The air gap has a length of not less than 1 mm, preferably, not less than 1 mm to not more than 1,000 mm, more preferably not less than 1 mm to not more than 200 mm.

For the coagulation bath, a liquid (non-solvent) capable of inducing phase separation of the membrane-forming stock solution, but incapable of dissolving the acrylonitrile-based polymer, such as, water; alcohols such as methanol, ethanol, etc.; ethers; and aliphatic hydrocarbons such as n-hexane, n-heptane, etc. can be used, but water is preferable from the viewpoint of safety. Furthermore, it is possible to control the coagulation rate by adding a good solvent for the acrylonitrile-based polymer to the coagulation bath.

The temperature of the coagulation bath is −30° C. to 90° C., preferably 0° C. to 90° C., more preferably 0° C. to 80° C. At a coagulation bath temperature of higher than 90° C. or lower than −30° C., the membrane surface state will be unstable in the coagulation bath.

The present invention will be described below, referring to Examples, but will not be limited thereto.

Measuring procedures are as follows:

Hollow fiber membranes used as samples were all those thoroughly impregnated with water.

Water permeability of hollow fiber filtration membranes was determined by allowing ultrafiltration water at 25° C. to permeate through a 50 mm-long sample of hollow fiber filtration membrane from the inner surface to the outer surface, calculating a water permeation rate per unit time, unit membrane area and unit pressure (unit intermembrane differential pressure) and expressing it in liters/hr/m²/atm, where the available membrane area was based on the outer surface area.

Breaking strength and breaking elongation of membranes were determined by Autograph AGS-5D made by Shimadzu Corp. under such conditions as sample length:50 mm, tensile speed: 10 mm/min, and temperature: 25° C.

Breaking strength is expressed by a load (kgf) per hollow fiber membrane at breaking and breaking elongation by a ratio of elongated length at breaking to original length (%).

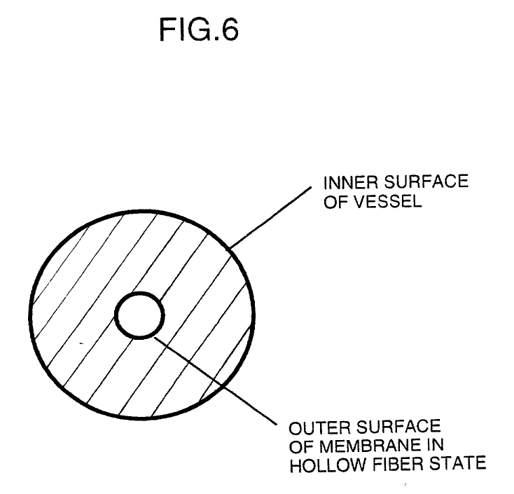

Selectivity (A) shows a blocking rate, when an aqueous phosphate buffer solution (concentration: 0.15 moles/l and pH: 7.4) containing 0.025% by weight of bovine serum albumin (molecular weight: 67,000, made by SIGMA) was filtered through a 70 mm-long hollow fiber filtration membrane from the outer surface to the inner surface of the membrane for 40 minutes under such cross-flow conditions as an average pressure between the inlet pressure and the outlet pressure of 0.5 kgf/cm² and a fluid linear velocity of 1 m/sec. The fluid linear velocity was calculated from an area obtained by subtracting a cross-sectional area, which was calculated from the outer diameter of a hollow fiber filtration membrane, from the cross-sectional area of a cylindrical vessel (see FIG. 6). Concentration was measured by an ultraviolet spectrophotometer at a wavelength of 280 nm.

Selectivity (B) was determined in the same manner as the selectivity (A) except that the aqueous solution to be filtered was changed to an aqueous 0.1 wt. % solution of dextran having an average molecular weight of 2,000,000 (Dextran T-2000 made by Pharmacia Biotech). Concentration was measured by a refractometer at 25° C.

Chemical resistance was shown by percent changes in breaking elongation and breaking strength when dipping a hollow fiber filtration membrane at 25° C. for 120 hours into an aqueous solution prepared by mixing pure water with sodium hypochlorite so as to make an available chlorine concentration of 1,200 ppm and with sodium hydroxide so as to made 4,000 ppm (0.1 N (normal)). Bath ratio (dipping volume ratio) of membrane to chemical solution was 1 to 100. Chemical solution was renewed at every 24 hours.

Intrinsic viscosity of acrylonitrile-based polymer was determined according to the procedure disclosed in Journal of Polymer Science, A-1, Vol. 6, 147-157 (1968), using N,N-dimethylformamide at 30° C.

### EXAMPLE 1

(Present Invention)

18.5% by weight of a copolymer having an intrinsic viscosity [y]=1.2, consisting of 91.5% by weight of acrylonitrile, 8.0% by weight of methyl acrylate and 0.5% by weight of sodium methallylsulfonate, and 21.0% by weight of polyethylene glycol having a weight average molecular weight of 600 (PEG 600 made by Wako Pure Chemical Co., Ltd.) were dissolved into a solvent mixture consisting of 9.15% by weight of propylene carbonate and 51.85% by weight of dimethyl sulfoxide to made a homogeneous solution. Water content of the solution was measured by a Karl Fischer water analyzer and found to be not more than 600 ppm. The solution was kept at 60° C. and discharged through a spinneret (coaxial tube spinneret: 0.5 mm-0.7 mm-1.3 mm) together with a bore solution, which was a mixed solution (viscosity at 20° C.: 24 cp) consisting of 50% by weight of tetraethylene glycol and 50% by weight of water, passed through a 20 mm-long air gap and then through a coagulation bath having a total length of 5 m consisting of water at 43° C. to obtain a hollow fiber filtration membrane, where the passage from the spinneret to the coagulation bath was enclosed by a cylinder and the relative humidity in the air gap zone within the cylinder was controlled to 100%. The spinning speed was set to 10 m/min. The resulting hollow fiber filtration membrane was dipped into pure water at 25° C. for one day to fully remove the residual solvents from the membrane. The residual amount of polyethylene glycol, propylene carbonate and dimethyl sulfoxide in the wet membrane was not more than 1 ppm. Furthermore, the resulting hollow fiber filtration membrane was dipped into pure water at 20° C., heated at a heating rate of 15° C./hr and kept in water at the ultimate temperature of 55° C. for 2 hours.

The resulting hollow fiber filtration membrane was observed by an electron microscope and found to be an inclined structure with continuously increasing pore size from both the inner and outer surfaces towards the center of the membrane as well as a sponge structure free from polymer defect sites having sizes larger than 10 μm. No pores larger than 0.02 μm were found on the outer surface of the membrane, whereas numerous slit-shaped stripes and slit-shaped pores were observed on the inner surface. Performance and structure of the membrane are shown in Table 1. When chemical resistance was determined by dipping the membrane into an aqueous sodium hydroxide-added sodium hypochlorite solution. Neither change nor decrease was observed in breaking strength and breaking elongation of the membrane. The results are shown in Table 1. Neither change nor decrease was also observed in water permeability or selectivity.

### EXAMPLE 2

(Comparative)

A membrane (inner diameter/outer diameter=760/1,350 (μm)) was obtained according to Example 1 of JP-B-52-15072, using the same acrylonitrile-based polymer and spinneret as used in Example 1.

Observation of the resulting hollow fiber filtration membrane by an electron microscope revealed that there were a plurality of polymer defect sites (voids) having sizes of 15 μm to 80 μgm on the cross-section of the membrane and numerous slit-shaped stripes and slit-shaped pores on the inner surface of the membrane, but there were no pores larger than 0.02 μm on the outer surface of the membrane. The properties, structure and chemical resistance results of the membrane are shown in Table 1.

### EXAMPLE 3

(Comparative)

A hollow fiber filtration membrane was obtained in the same manner as in Example 1, using the same composition ratio of the polymer, solvent and additive in the membrane-forming solution, except that the kind of the solvent was limited to dimethyl sulfoxide and the bore solution was changed to an aqueous 80 wt. % dimethyl sulfoxide solution. Observation of the resulting hollow fiber filtration membrane by an electron microscope revealed that it had such an inclined structure that pore sizes are continuously increased from the outer surface of the membrane towards the inner surface of the same and also a sponge structure containing no defect sites of sizes larger than 10 μm. No pores larger than 0.02 μm were observed on the outer surface of the membrane, whereas circular pores were observed on the inner surface. Properties of the resulting membrane are shown in Table 1.

TABLE 1

| | Example 1 | Example 2 | Example 3 |
|---|---|---|---|
| | (Present | (Compara- | (Compara- |
| | invention) | tive) | tive) |
| Inner diameter (μm) | 760 | 760 | 760 |
| Outer diameter (μm) | 1340 | 1350 | 1350 |
| Presence of larger polymer | None | Yes | None |
| defect sites than 10 μm | | | |
| Average pore size on outer | 0.02 | 0.02 | 0.02 |
| surface (μm) | | | |
| Average pore size on inner | 0.08 | 0.02 | 5.0 |
| surface (μm) | | | |
| Water permeability | 350 | 110 | 350 |
| (l/hr/m²/atm) | | | |
| Selectivity (A) (%) | 92 | 98 | 90 |
| Selectivity (B) (%) | 96 | 96 | 90 |
| Breaking strength (kgf) | 0.54 | 0.45 | 0.35 |
| Breaking elongation (%) | 64 | 36 | 47 |
| Strength × elongation | 34.56 | 16.20 | 16.45 |
| product (kgf · %) | | | |
| Percent change in breaking | 0 | 75% | 30% |
| elongation after dipping | | lowered | lowered |
| in chemical solution (%) | | | |
| Percent change in breaking | 0 | 4% | 10% |
| strength after dipping in | | lowered | lowered |
| chemical solution (%) | | | |

### INDUSTRIAL UTILITY

The present membrane has high mechanical strength, elongation and water permeability and also high chemical resistance and filtration reliability, and thus is suitable for use in the field of tap water purification such as decontamination of natural water, e.g. river water, lake water, underground water, sea water, etc., removal of microorganisms, preparation of germfree water, etc.; the field of coating material recovery from electrodeposition coating solutions; the field of ultrapure water production for the electronic industry; and the field of medicines, fermentation and food.

1. A polyacrylonitrile-based hollow fiber filtration membrane obtained by a process which comprises:
discharging a membrane-forming solution comprising an acrylonitrile-based polymer, a solvent mixture of propylene carbonate and an organic solvent, and an additive through a coaxial tube spinneret together with a bore solution which is capable of inducing phase separation of the membrane forming solution, wherein the bore solution has a viscosity of not less than 15 cp (centipoises) at 20° C.;
passing both solutions through an air gap; and
then coagulating the membrane-forming solution in a coagulation bath.

2. The polyacrylonitrile-based hollow fiber filtration membrane according to claim 15, wherein the pores have an average pore size of not more than 1 μm and the average pore size on at least one of the surfaces is not less than 0.01 μm.

3. The polyacrylonitrile-based hollow fiber filtration membrane according to claim 15, wherein average pore size on the inner surface of the membrane is larger than that on the outer surface of the membrane.

4. The polyacrylonitrile-based hollow fiber filtration membrane according to claim 15, wherein the membrane comprises an acrylonitrile-based polymer having an intrinsic viscosity of not less than 0.4 to less than 2.0.

5. The polyacrylonitrile-based hollow fiber filtration membrane according to claim 15, wherein said membrane exhibits percent changes of less than 20% in breaking strength and breaking elongation of said membrane before and after dipping in an aqueous hypochlorite solution at a solution temperature of 25° C. for 120 hours, wherein the aqueous hypochlorite solution contains 0.1 N of an alkali and has an available chlorine concentration of 1,200 ppm.

6. A process for producing the polyacrylonitrile-based hollow fiber filtration membrane, which comprises:
discharging a membrane-forming solution comprising an acrylonitrile-based polymer, a solvent mixture of propylene carbonate and an organic solvent, and an additive through a coaxial tube spinneret together with a bore solution which is capable of inducing phase separation of the membrane forming solution, wherein the bore solution has a viscosity of not less than 15 cp (centipoises) at 20° C.;
passing both solutions through an air gap; and
then coagulating the membrane-forming solution in a coagulation bath.

7. The process according to claim 6, wherein a concentration of propylene carbonate in the solvent mixture is not less than 2% by weight to not more than 99.9% by weight.

8. The process according to claim 6, wherein the additive is polyethylene glycol having a molecular weight of not more than 1,000.

9. The process according to claim 6, wherein the bore solution is a solution containing a glycol or a glycerol having a molecular weight of not more than 1,000.

10. The polyacrylonitrile-based hollow fiber filtration membrane according to claim 15, which further comprises an acrylonitrile homopolymer or an acrylonitrile-based copolymer, wherein the acrylonitrile base copolymer comprises at least 70% by weight of acrylonitrile and not more than 30% by weight of at least one vinyl compound copolymerizable with the acrylonitrile.

11. The polyacrylonitrile-based hollow fiber filtration membrane according to claim 10, wherein the vinyl compound is at least one selected from the group consisting of acrylic acid, methyl acrylate, ethyl acrylate, methacrylic acid, methyl methacrylate, ethyl methacrylate, itaconic acid, vinyl acetate, sodium acrylsulfonate, sodium methallylsulfonate, sodium p(para)-styrene sulfonate, hydroxyethyl methacrylate, ethyl methacrylate triethylammonium chloride, ethyl methacrylate, trimethylammonium chloride and vinyl pyrrolidone.

12. The process according to claim 6, wherein the organic solvent is selected from the group consisting of dimethyl sulfoxide, N,N-dimethylformamide, N,N-dimethylacetamide, γ-butyrolactone, ethylene carbonate, N-methyl-2-pyrrolidone, 2-pyrrolidone, and hexamethylene phosphamide.

13. The process according to claim 6, wherein the additive is at least one selected from the group consisting of water, salt, isopropyl alcohol, methanol, ethanol, propanol, butanol, acetone, methyl ethyl ketone, diethylene glycol, triethylene glycol, tetraethylene glycol, polyethylene glycol having a weight average molecular weight of 200 to 35,000, glycerine and polyvinylpyrrolidone having a weight average molecular weight of 1,000 to 2,800,000.

14. The process according to claim 6, wherein the bore solution comprises at least one selected from the group consisting of ethylene glycol, propylene glycol, trimethylene glycol, 1,2-butylene glycol, 1,3-butylene glycol, 2-butyne-1,4-diol, 2-methyl-2,4-pentanediol, 2-ethyl-1,3-hexanediol, glycerine, tetraethylene glycol, polyethylene glycol 200, polyethylene glycol 300, and polyethylene glycol 400.

15. A polyacrylonitrile-based hollow fiber filtration membrane according to claim 1, which comprises:
a sponge structure having an inner surface and an outer surface; and
pores having pore sizes not more than 10 μm in the membrane, wherein the pore sizes continuously decrease in directions towards the inner surface and the outer surface of the membrane so that the pore size on the inner surface of the membrane is different than the pore size on the outer surface of the membrane.
